(19) United States
(12) Patent Application Publication
(10) Pub. No.: US 2009/0070179 A1
(43) Pub. Date: Mar. 12, 2009

(54) Impact meter

(76) Inventors: Julian Renato Kalmar, Marina Del Rey, CA (US); Richard Paul Beneteau, Brantford (CA); Robert Evans, Ashland, OR (US)

Correspondence Address: JULIAN KALMAR, 4712 ADMIRALTY WAY #223, MARINA DEL REY, CA, 90292, US

(21) Appl. No.: 12/148,443

(22) Filed: Apr. 18, 2008

Related U.S. Application Data
(60) Provisional application No. 60/925,250, filed on Apr. 19, 2007.

(51) Int. Cl. G06Q 10/00

(52) U.S. Cl. 705/8; 705/11

(57) ABSTRACT

A system, means, and method for providing real-time feedback to a contributor of a charitable cause is described. It allows the contributor to see both the good they are doing directly, and the good being created by all the people who take positive actions as a result of the contributor's own actions. Thus, it provides real-time visibility into the direct and indirect effects of the contributor's actions.

### PARENT CASE TEXT

This application claims priority from U.S. Provisional Patent Application Ser. No. 60/925,250, filed Apr. 19, 2007. The contents of that application are incorporated by reference herein.

### BACKGROUND OF THE INVENTION

This invention relates to helping organizations encourage people to help them achieve a particular purpose. It does this by helping participants understand that the effect they are having towards achieving that purpose is both measurable, and significant. In doing this, the invention encourages further participation because participants feel empowered by seeing instantaneous results appear before their eyes. [This is often in sharp contrast to the mind-numbing environments one often sees in large organizations where individuals rarely know the overall goal and have no idea how their work contributes to it.]

Although the invention was created during the course of development of a charitable not-for-profit organization, and the following discussion is focused on how the system may be used to advantage in similar organizations, the invention can be equally well applied to for-profit organizations.

The invention seeks to provide real-time or near real-time feedback to participants working to support a particular cause or purpose. It helps facilitate involvement and communication between the organization and participants by showing participants how much good their efforts are doing. In other words, the invention relates to showing the impact a participant's actions are having towards the stated objective.

As a pertinent example, let us discuss the situation experienced by not-for-profit charity organizations seeking donations, and the effect their organization has on participants.

Existing charities typically solicit donations from people sympathetic to the charity's cause. Receipt of donations by the charity is usually responded to immediately with some form of gratitude, and often with a re-affirmation of the importance of the cause and how much good the donor's contribution will do. Very often there is a request for additional contributions. The donor's name then goes on a mailing list of some form and they are repeatedly solicited for additional contributions.

A major difficulty with this methodology is that it is difficult to make donors feel that they are really contributing to something worthy, because no direct feedback is available to the donor to see with their own eyes how they have helped. To solve this, organizations involved in charitable work, typically send out newsletters or other forms of communication showing how much good has been accomplished as a direct result of all donors' contributions. While this does address the problem to a degree, it lacks immediacy and is not very effective in helping the individual donor feel they have made a significant contribution because the effect of all donations is lumped together when the organization expresses all the good that has been done.

In some organizations, another major difficulty is that there is no sense of specifically what a donor's contribution has improved. For example, if a donor gives $10, what specifically does that cause to happen? To resolve this, charitable organizations often try to quantify how much money is required to cause a specific effect. This is generally done during the solicitation to encourage donations. However, specific contributions are often responded to with a form letter that expresses thankfulness for the monetary value, rather than for the quantified charitable effect the organization promised. This oversight leaves the donor somewhat alienated and diminishes their likelihood of repeated donation.

A further difficulty facing charitable organizations is that they must rely on repeated outreach programs that produce donations always in proportion to the number of times they correspond and the quality of their correspondence. They cannot grow their membership or their donations appreciably unless they keep reaching out, themselves, and especially to new groups of people.

What they lack is “word-of-mouth” advertising that spreads the message about their good work far beyond those who originally received the organization's correspondence.

In summary, donors often do not receive an immediate, tangible sense of their own kindness and this alienates them, and significantly diminishes the likelihood that they'll encourage their friends to participate in the same charity. They are left with the sense that they gave money to a cause that just keeps asking for more money without any end in sight and nothing tangible to show for their donations.

Clearly there is need to provide a novel method, system and product to help charitable organizations and other for-profit organizations achieve their objectives.

### PRIOR ART

Although many processes and systems have been used to try to alleviate the difficulties described above, most lack efficacy, and the good that could be done by the organizations employing them is limited as a result.

This invention has characteristics similar to numerous other systems common in the marketplace, but never have they been combined in the unique manner presented here. Here is the following prior art known to the inventors.

One embodiment of this invention has been created for use on the Internet, and other Internet-based systems share characteristics of this invention. For example, there are numerous systems that share the feature of being able to track donations made by donors to a charitable cause. The amount of money donated can be presented to the donor when requested, typically as part of a year-end statement. Some systems might even present the total contributions made by the donor to-date as part of correspondence or as part of some other information displayed to a donor, like their personal membership profile within a particular organization. This simple tracking is common, but only shows the monetary value contributed by that donor, not the combined effect of that donor's contributions plus their friends' contributions, the friends they influenced to help the organization's cause.

Other Internet systems do track and display how much money a person might have earned as a result of sales commissions. These systems can display, to a sales person, the sales they've made along with computed values such as expected sales commissions based on those sales.

In yet other systems, not only are a person's sales commissions displayed, but when they've influenced other people to become salespeople as well, they can receive additional commissions for sales made by the other sales people who they were responsible for bringing into the sales force. When such organizations of sales people have many levels, they are referred to as Multi-level Marketing programs (MLM) and they sometimes have systems that can display numerous levels of sales people and the commissions an individual sales person is expected to receive based on sales and the number of sales people associated with them; associates of associates and so on, many levels removed.

Additionally, there are Internet websites such as FaceBook (www.facebook.com) and MySpace (www.myspace.com) that are dedicated to social exchanges amongst users of their service. Such services have a means of allowing users of their service to know when other related users have done something on the website, such as joining a discussion group, updating their personal information, and so on. Communication provided by social networking sites is unfocused and does not relate to this invention.

These kinds of prior art inventions serve only to provide status information or allow general communication amongst groups of people. They are significantly different, often more limited in scope, and for different applications than our invention. They do not purposefully engage, focus, and empower participants of organizations in the way ours does, and therefore they do not have the capacity to cause people to take positive actions to the degree our invention does.

### SUMMARY OF THE INVENTION

The invention may take many forms, but a common form is as a computer program running on an Internet website. The website server is responsible for storing, retrieving, processing, presenting, and communicating electronic data in human-readable form.

The invention can be configured so that the data it presents is readily understandable through commonly available Internet browser programs, thus making it easy for anyone, anywhere in the world to use the invention.

The invention is further summarized according to its important characteristics. Understand that this invention's purpose is to help facilitate, and otherwise encourage, people to help an organization achieve a stated objective. Thus, we make frequent references to “users” of the invention as “participants,” and these terms are used interchangeably.

Tangible Effects. According to the invention, there is provided a means of giving immediate and tangible feedback to a user of the invention regarding the significance of their actions relative to an organization's stated objective.

Electronic Storage of Data. The invention contains a means of electronically storing data. It has associated algorithms and means of storing, retrieving, processing, and presenting this data rapidly so that real-time or very nearly real-time behavior is obtained from it.

Real-time and Near Real-time Feedback. An essential aspect of this invention is that it can provide nearly instantaneous reporting of positive effects to each participant. The effect of this is that participants feel empowered, because they can see their measurements changing as a direct result of their current and past actions.

Some seemingly minor actions can have dramatic effects. Furthermore, some actions can have effects that continue to propagate for years, and thus produce positive results towards the desired objective for extended durations. Results that accrue over the long term are dutifully recorded by the invention, and participants are often surprised at how their earlier actions continue to produce positive effects so long afterwards.

Multiple Measurement Categories. The invention readily provides organizations the ability to display and demonstrate, to participants, the effect they're having in more terms than just monetary value. While the invention could show monetary success only, it is typically configured to show 5 or more different measurement categories, and will readily show the participant's effect or “score” in each category. This capacity permits organizations to involve many more people than simply donors, and it is this aspect that can create huge numbers of volunteers who support the organization even though they don't donate financially themselves.

Infinite Levels of Tracking and Measurement. The invention is further capable of displaying the effects of an infinite number of levels of participants who get other participants involved. Thus, in each measurement category, a participant can see not only their own positive effect, but the effects of other participants that they were responsible for involving in the organization's mission. These secondary positive effects very often exceed the individual participant's positive effects, and are thus very encouraging to the participant. Participants start to understand that although their own actions might be small, they can have a very large and significant effect on the overall success of the organization's mission.

Status Information With Suggested Actions. The invention not only provides status information showing a participant's current measurements, it provides a direct means of immediately improving one's measured effect in each category. This makes it very easy and simple for a participant to quickly maximize their impact on the organization's mission.

Viral Marketing Methods. A very powerful feature of this invention is that it can be configured to provide immediate ways for a participant to encourage large numbers of additional participants to help the organization reach its objectives. This can become so effective that, on average, each participant gets at least one other participant involved. Over time, the number of participants naturally increases due to this effect, and can cause the number of participants to grow exponentially. In this way, the organization can acquire huge numbers of willing helpers all working towards the organization's objective. This becomes extremely cost effective for the organization because they do not have to explicitly set out to find additional participants. The existing participants find more participants, thus diminishing hiring and advertising costs.

Excitement spreads from person-to-person about the organization's mission, thus minimizing marketing and education costs. It is entirely possible for an organization to develop a huge following without paying for traditional advertising. When advertising or promotion does take place, it can produce a much higher response than regular programs because the referral, or word-of-mouth, effect multiplies the number of people responding. Making viral marketing methods available directly to every participant allows them to launch their own miniature promotions for the organization without any direct expenses.

Encouragement. In this sense, the invention also contains intangible aspects that are not part of the physical invention. The invention tends to produce feelings of empowerment, hope, enthusiasm and other positive feelings in participants.

Computed Measurements. The invention can be further configured to display additional measures such as: averages, standard deviations, and many other mathematical computations. The results of these computations can be displayed to each participant, giving them a better understanding of their personal effects on the organization's objectives.

Graphing of Performance. The invention can be further configured to give graphical representations of the data, including performance as a function of time. This can be useful to the participant in seeing how their earlier efforts have been paying off.

Relative Comparisons. In addition, the invention is capable of showing a participant how their efforts compare with other participants, for example, by displaying an average of all participants right next to the individual's measurements in each particular category.

Dynamic Behavior and Notifications. The invention has a means of notifying participants whenever their previous actions have resulted in delayed positive effects. This aspect gives the invention dynamic characteristics that continue to excite and encourage participants.

Computer-based Volunteering. The invention can encourage participants to use computer-based actions so that positive effects can be obtained without the participant ever leaving their computer or wireless device. As a result, numerous brief actions can be accomplished to promote the organization's objectives conveniently, and without the usual burden of asking volunteers to meet at a pre-designated place to perform volunteer activities. In other words, when there are many more ways of volunteering, many more people show up to help an organization's mission. This bypasses many difficulties in organizing and encouraging volunteers since it eliminates restrictions on duration, schedule conflicts, inconvenience, and other obstacles. The actions are also fun because they are easy, fast, and convenient, and, the results can be readily seen. Volunteering so easily allows participants to achieve positive results in the span of a coffee break.

Due to these characteristics, this invention is thus of very general utility and is applicable to almost every conceivable form of charity or fundraising project whether they are not-for-profit, or for-profit. It solves the problem of giving an immediate and tangible sense of accomplishment to those who support the organization and its objectives, and it encourages participants to involve their friends, thus virally spreading the message of the organization without any expenditure on the part of the organization. The invention provides specific feedback immediately and alerts all participants of the new activity they have sparked, directly, or indirectly, no matter how many generations removed.

### DRAWINGS

The invention is further described according to the accompanying drawings, which are taken from an actual embodiment of this invention for a peace project's website.

### BRIEF DESCRIPTION OF THE DRAWINGS

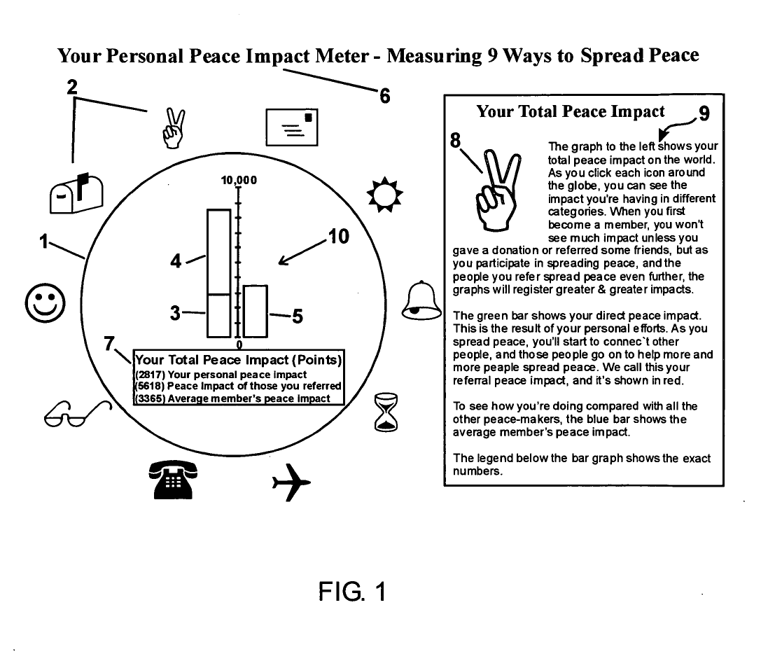

FIG. 1 shows a preferred embodiment of the invention on an internet website dedicated to creating world peace (www.tenmillionclicksforpeace.org). This embodiment is directed towards aspects of creating and spreading peace. Again, the invention is configurable, so it may be directed towards any type of charity, awareness effort, fundraising effort, or profitable enterprise.

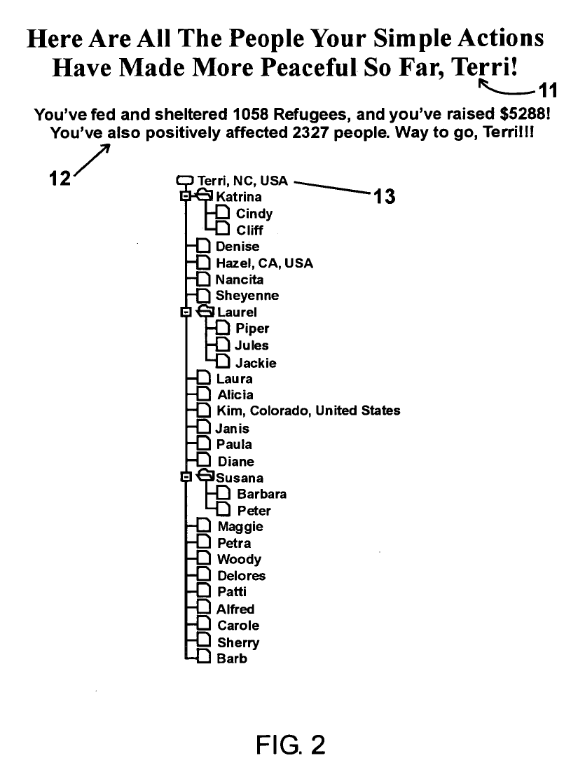

FIG. 2 shows an example of the effect a single participant has had by inviting friends to join the project, who then went on to become participants, and refer their friends, and so on.

### DETAILED DESCRIPTION OF THE PREFERRED EMBODIMENT

The invention consists of a number of important visual components. The preferred embodiment of FIG. 1, shows a Peace Impact Meter 6 capable of measuring and displaying nine measurement categories and one summary category. It further shows an aesthetically pleasing background image 1, and a variable number of icons 2 that surround 1. Each icon 2 can be mouse-clicked, thus choosing a different measurement category. When an icon 2 is clicked, the entire display refreshes and new information is presented to the user, consisting of the other numbered points (3-5 and 7-10) as described next.

Measurements can be displayed in a variety of formats. In this preferred embodiment, an auto-scaling bar graph 10 has been annotated with exact numerical values of measurements in the graph legend 7. The legend 7 explains the meaning of the different bar graph bar segments 3, 4, and 5. The leftmost bar consists of segments 3 and 4, representing the total measured effect this user has caused in the current measurement category. This measured effect consists of two parts, the user's direct effect 3 that they caused to happen personally, and the indirect effect caused because this user influenced others to join and support the organization's objectives 4.

An example of a computed, auxiliary measurement is the average user's effect 5 shown as the rightmost bar of the bar graph. This serves as a comparison from which the user can judge how well they are doing in helping the organization relative to the average. Many other types of data can be provided to help the user understand their positive effect and encourage them to continue working towards the organization's objectives.

When an icon 2 is clicked, the entire contents of the bar graph (3, 4, 5, 7, and 10) change to reflect the new category and the current associated measurements for this user. The user learns that the image 8 on the right side is always given as a guide as to which category's measurements are currently displayed. In addition, the right side of the screen 8 and 9 change, when an icon 2 is clicked, to provide the user with specific information about the chosen category, and even better, what they can do to improve their score in the selected category. In the case shown in FIG. 1, the category selected is the summary category and the text of 9 offers a summary of how to use the invention. For other measurement categories, however, 9 contains explicit examples of actions the user can take from their computer to improve the positive effect they're having. These actions consist of Internet hyperlinks that allow the user to take immediate action.

Referring to FIG. 2, there is another depiction of how the user is causing a positive effect, in this case, a personalized 11 and 13 display of the people this user has influenced to help the organization. Shown in 12 is a summary of some of the good the user has caused in multiple measurement categories: Refugees helped, dollars raised, and the total number of people positively influenced by the user's actions (in this case). In 13, the user (“Terri”) can see a tree diagram that shows not only the people they've caused to join, but the complete hierarchy as friends, invited friends, who invited their friends, and so on. This display is unlimited in the number of referral generations.

It should be noted in FIG. 1 that all aspects of this embodiment are configurable, including the number of measurement categories (and associated icons 2 and 8), the type of graph display (a bar graph 10 in this embodiment), and the textual description 9 for each measurement category.

In addition, to the visible parts of the invention, there are other supporting elements that comprise the algorithms and physical computer or other hardware needed to make the invention function properly and reliably. These include:
1. A means of storing and safeguarding the data of each user, and the relationship of users to one-another.
2. A collection of algorithms for adding, subtracting, or changing the scores displayed on the impact meter according to the actions of the user (i.e. participant), and all those related to the user no matter how far removed.
3. Additional algorithms and processes used to maintain the data used by the invention.
4. A means of alerting users “upstream” from a user who has taken positive action.
5. A means of allowing a user to easily refer their friends, acquaintances, co-workers, and so forth.
6. An “autoresponder” algorithm that permits appropriately time-delayed messages to be sent to users for a great variety of circumstances.
7. An algorithm that allows a user to selectively show other people their meter readings.

In FIG. 1 of this preferred embodiment, various icons and descriptive phases are shown. However the number of icons, the size of icons, the location of icons, the descriptive phases, the text and graphics that can be displayed, the positioning, the graphical configuration, and all other visible aspects are examples only. The invention is completely configurable. There are a great variety of ways this invention can be implemented, and configured.

The preferred embodiment is merely representative of one form of the invention implemented on a computer website. There are numerous configurations that would all produce the advantages and effects of this invention, some of which are described next.

### VARIATIONS OF THE PREFERRED EMBODIMENT

The invention is not limited to operation on Internet websites. Many forms of this invention exist. Some diverse examples of implementing this invention are:
1. An audio-only version capable of being implemented through a cellular phone service, for example.
2. A Braille device implementation.
3. An ATM (automated teller machine) or kiosk implementation.
4. A wireless device implementation that could take any number of forms.

Numerous variations of the preferred embodiment are possible because there are an infinite number of geometrical, graphical, numerical and other superficial variations of the ways this invention could be implemented, all with the goal of communicating the effect a user has in attracting and influencing other people towards promoting the objective for which the invention is being used. Generally, this invention would be implemented as an electronic device, however, all-optical, all mechanical, or a combination of optical, electronic and mechanical hybrid implementations could also be fabricated, including devices specifically designed and dedicated for this purpose. Numerous other variations exist, all with the idea of solving the fundamental problems listed at the beginning of this application.

Many other forms of this invention exist, each differing from the others in matters of detail only. It is to be understood that the foregoing description and accompanying drawings set forth the preferred embodiment of the invention at the present time. Various modifications, additions, and alternative designs will, of course, become apparent to those skilled in the art in light of the foregoing teachings without departing from the spirit and scope of the disclosed invention. Therefore, it should be appreciated that the invention is not limited to the disclosed embodiments, but may be practiced within the full scope and spirit of the appended claims.

What is claimed is:

1. A multi-user measuring and action-taking system configured to achieve a particular objective, and which is capable of:
a) Permitting the editing and configuration of the system, the number of measurement categories, the presentation, and the internal processes; and,
b) Measuring, displaying, and storing a configured number of measurable characteristics; and,
c) Allowing a user to select which characteristic to display; and,
d) Storing supporting algorithms; and,
e) Displaying measurements in real-time, or near real time, for any particular user; and,
f) Storing, and optionally displaying, the relationships of various users to each other without limit within a given system; and,
g) Being used by one or multiple people at the same time; and,
h) Showing each user one or multiple effects they are responsible for creating; and,
i) Permitting each user the opportunity to take one or more actions in support of the underlying objective for which the system has been configured; and,
j) Inviting one or more other people, at the direct request of a given user, to also use the system and to educate those invited about the underlying objective for which the system has been configured; and,
k) Showing each user which actions to perform to improve their scores for each measured characteristic; and,
l) Updating measurements of an up to infinite number of related users of the system whenever a given user performs an action that causes their own measurement to change.

2. A system as in claim 1 that optionally can do one or more of the following:
a) Maintain a running count of the various characteristics being measured, or a subset of the total running count.
b) Alert users when their measurements change, or when another user's measurements change, immediately, or on a per-time-period basis.
c) Translate measured scores to an alternate measurement basis, or bases.
d) Separately display measurements caused by a current user from measurements caused by users related to the current user.
e) Indicate computed values based on a subset of measurements either for the current user, or the entire system or groups of users. For example, the system can be configured to display: the average user's measurement in a given category or over all categories, the median, mode, standard deviation, and so on.
f) Display a graph of time-dependent measurements or any other type of information based on the measurements made for a given user, a group of users, or all measurements.
g) Display and offer one or multiple methods to participate in the viral marketing of the system.
h) Send periodic messages to users as needed or on a scheduled basis.
i) Automatically refresh measurements displayed.
